(19) United States
(12) Patent Application Publication
(10) Pub. No.: US 2013/0133627 A1
(43) Pub. Date: May 30, 2013

(54) RECIPROCATING PISTON ENGINE

(71) Applicants: Manousos Pattakos, Nikea Piraeus (GR); Efthimios Pattakos, Nikea Piraeus (GR); Paraskevi Pattakou, Nikea Piraeus (GR); Emmanouel Pattakos, Nikea Piraeus (GR)

(72) Inventors: Manousos Pattakos, Nikea Piraeus (GR); Efthimios Pattakos, Nikea Piraeus (GR); Paraskevi Pattakou, Nikea Piraeus (GR); Emmanouel Pattakos, Nikea Piraeus (GR)

(21) Appl. No.: 13/816,230

(22) PCT Filed: Aug. 10, 2011
(86) PCT No.: PCT/IB11/53569

§ 371 Date: Feb. 9, 2013

(30) Foreign Application Priority Data
Aug. 10, 2010 (US) 12854165

(51) Int. Cl. F02B 75/28

(52) U.S. Cl. CPC F02B 75/28
USPC 123/51 BA

(57) ABSTRACT

A single-crankshaft single-cylinder fully-balanced opposed piston engine module that provides extra time for the injection and the combustion of the fuel.

Closest prior art: the WO 2007/085649 A2 Opposed piston Pulling Rod Engine (OPRE), the U.S. Pat. No. 6,170,443 Opposed Piston Opposed Cylinder engine (OPOC) and the U.S. Pat. No. 1,679,976 Junkers-Doxford engine. Close prior art is also the U.S. Pat. No. 4,732,115 of Lapeyre and the U.S. Pat. No. 4,115,037 of Milton.

The two connecting rods of the OPRE engine are ‘pulling rods’ or ‘pullrods’ in the sense that the high pressure of the combustion chamber loads them exclusively in tension. On the same reasoning the connecting rods of a conventional engine are pushrods.

The pullrod arrangement increases by some 35% (depending on the connecting rod to stroke ratio) the time the piston remains at the last 15% of its stroke near the combustion dead center, i.e. where the injection, the preparation of the fuel mixture, the delay and the most significant and efficient part of the combustion complete. On the same reasoning, when a pullrod engine revs at 35% higher revs than the conventional, it provides to the fuel similar conditions with the conventional.

The U.S. Pat. No. 4,732,115 of Lapeyre necessitates pairs of cylinders and simultaneous combustion at pairs of combustion chambers.

The U.S. Pat. No. 4,115,037 of Milton involves a crankshaft located necessarily at one side of the cylinder.

Some of the objects of this invention are:

to improve the balancing quality of the Junkers-Doxford engine;

to maintain the advantages of the OPRE engine, like the longer piston dwell around the combustion dead center, the crosshead architecture, the ‘four stroke like’ lubrication, the built-in volumetric scavenging pump etc, while eliminating the second crankshaft, the synchronizing gearing and the loads on the main crankshaft journals;

to provide a full-balanced single-cylinder single-crankshaft two-piston module;

to provide a single cylinder module for multicylinders;

to provide a port-less through-scavenged two-stroke engine having true four-stroke lubrication.

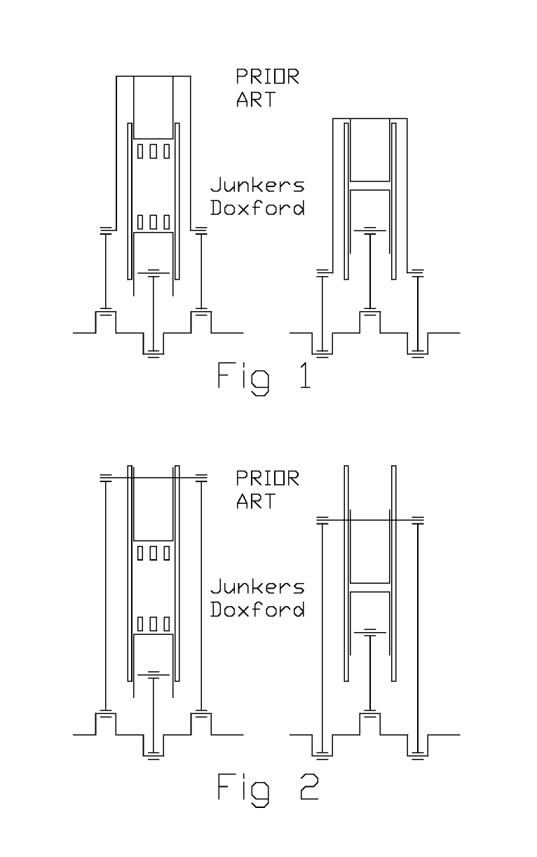

FIG. 1 shows the engine of Junkers-Doxford. The central connecting rod is a pushrod, the side connecting rods are pullrods.

FIG. 2 shows another version of the Junkers-Doxford engine wherein the side connecting rods extend to hold the piston pin.

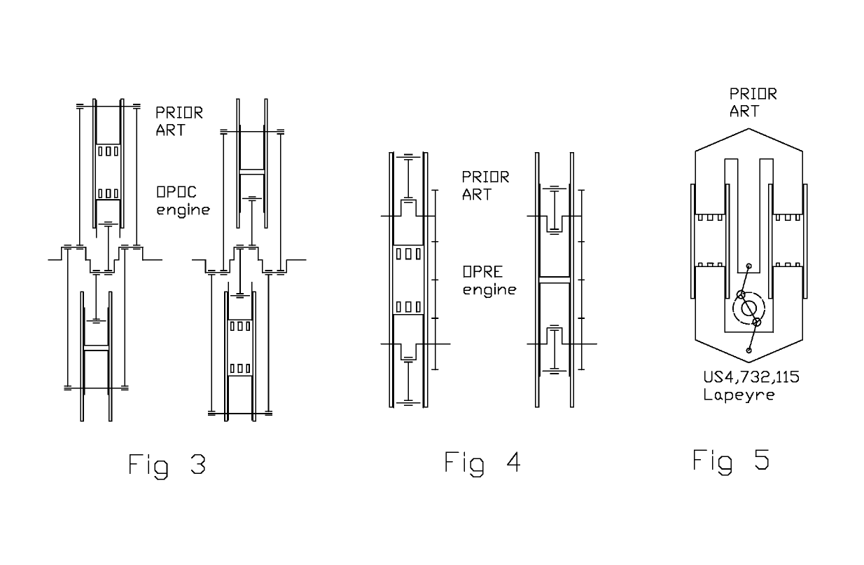

FIG. 3 shows the OPOC engine: two oppositely arranged Junkers-Doxford engines share the same crankshaft for the sake of a better dynamic balance with asymmetrical port timing.

FIG. 4 shows the OPRE engine comprising two synchronized crankshafts.

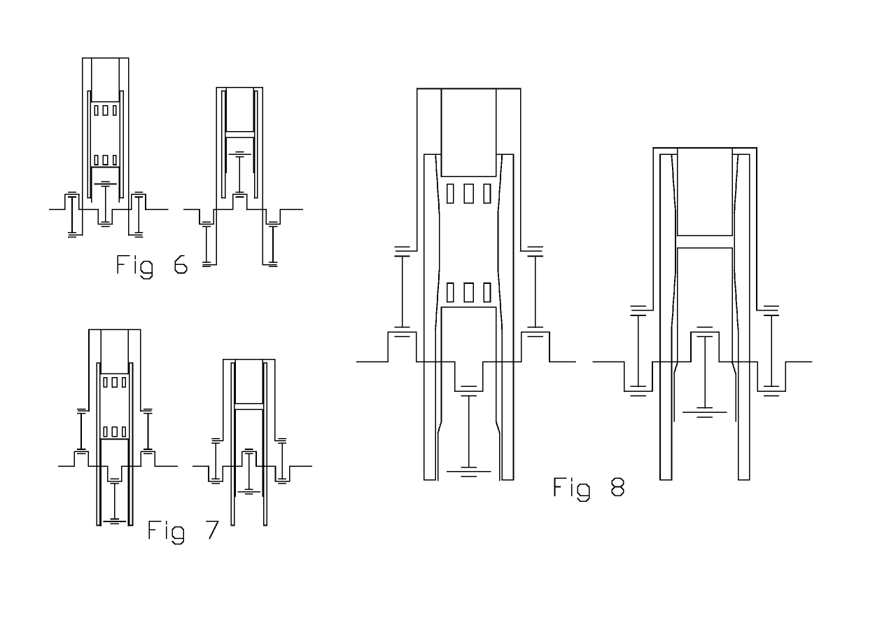

FIG. 5 shows the engine of Lapeyre.

FIG. 6 shows an embodiment of this invention wherein all the connecting rods are pushrods.

FIG. 7 shows another embodiment of this invention wherein all the connecting rods are pullrods.

FIG. 8 shows the arrangement of FIG. 7 with a different cylinder: the cylinder bore increases, i.e. it is tapered, at the two ends of the cylinder. This way the piston rings can avoid touching the bore at a good part of the piston stroke, with the corresponding reduction of the friction and the wear. The piston skirt at the combustion side of the piston needs not touch the cylinder because the thrust loads are taken at the ‘wrist pin’ side of the piston, away from the combustion chamber.

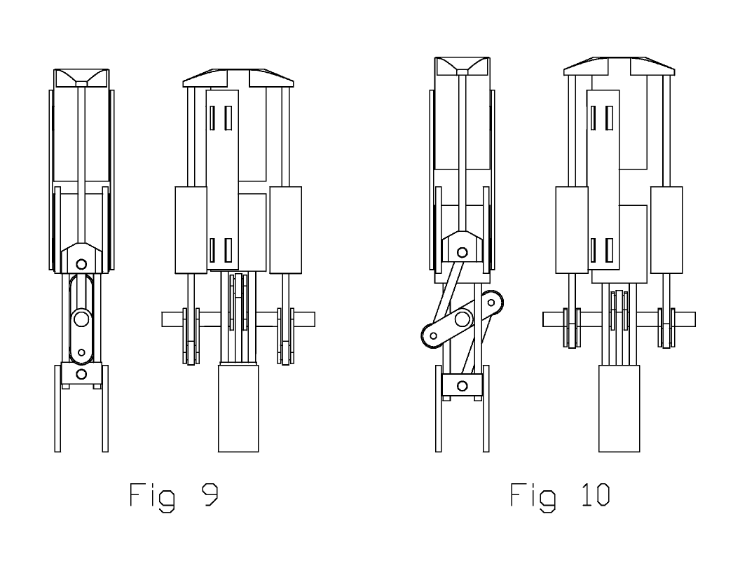

FIG. 9 shows an embodiment of this invention from two viewpoints. In this embodiment all connecting rods are pullrods. The cylinder is sliced to show more details. The pistons are at the combustion dead center.

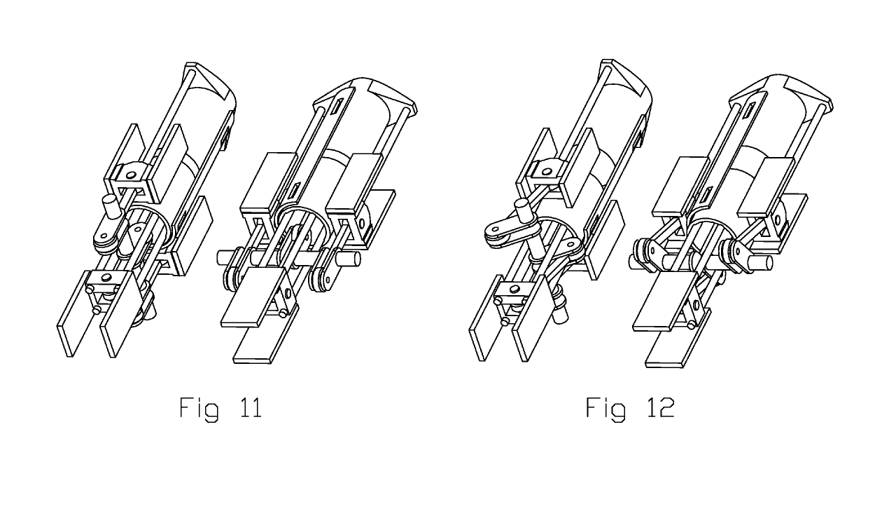

FIG. 10 shows the engine of FIG. 9 with the crankshaft rotated for 60 degrees.

FIG. 11 shows the engine of FIG. 9 from another viewpoint.

FIG. 12 shows the engine of FIG. 10 from another viewpoint.

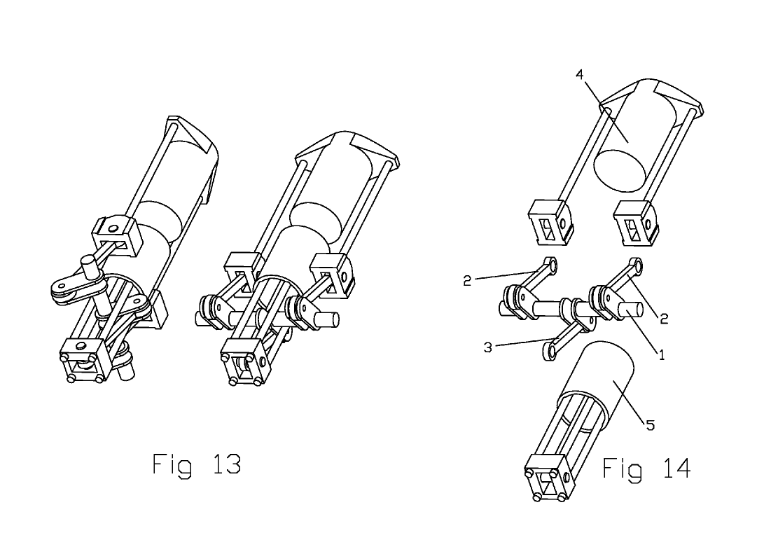

FIG. 13 shows the assembly of the pistons, the connecting rods and the crankshaft of the engine of FIG. 12.

FIG. 14 shows the assembly of FIG. 13 exploded.

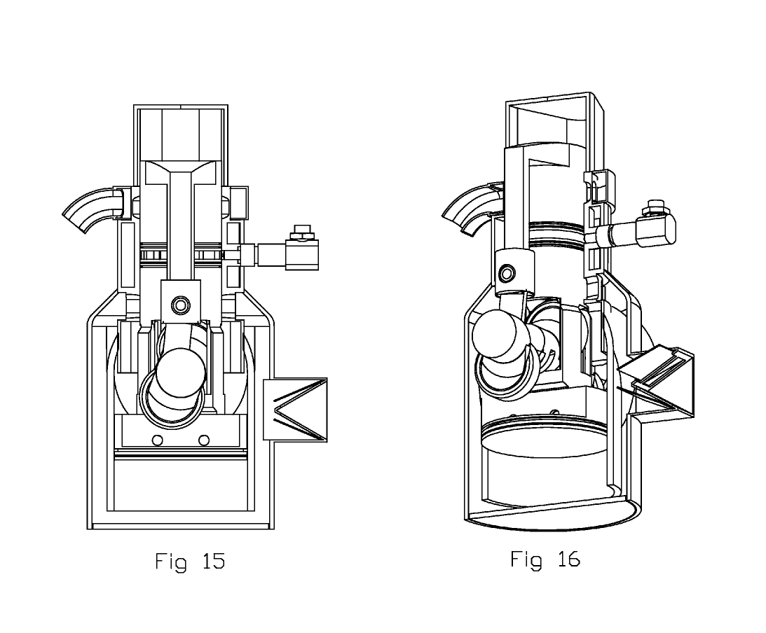

FIG. 15 shows another embodiment of this invention. The covers and the cylinder are sliced. A big diameter ‘scavenging’ piston is secured at the bottom of the lower piston and is slidably fitted into a big diameter cylinder that takes the thrust loads. The upward motion of the scavenging piston creates a vacuum that draws the air through the reed valve, shown at right. The downward motion of the scavenging piston displaces the air, the reed valve traps the air and when the piston uncovers the intake ports the pressurized air enters the combustion cylinder and scavenges the exhaust gas. An injector, shown at middle right, delivers the fuel.

FIG. 16 shows the engine of FIG. 15 from another viewpoint.

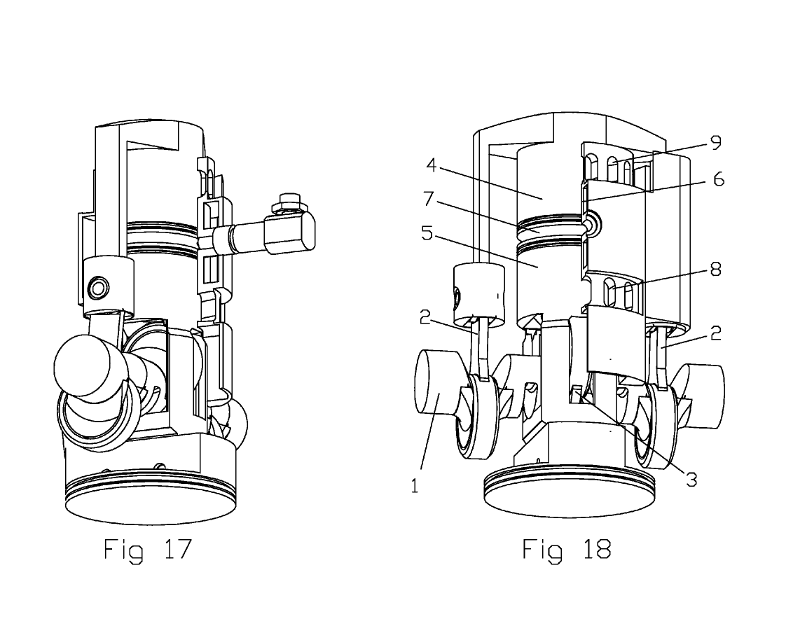

FIG. 17 shows the engine of FIG. 16 after the removal of some parts and covers.

FIG. 18 shows, from another viewpoint, the assembly of FIG. 17.

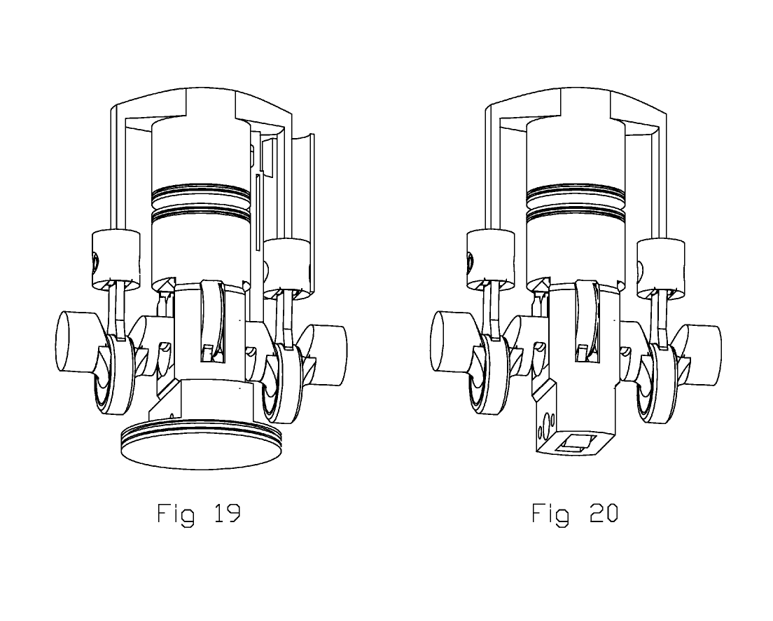

FIG. 19 shows the assembly of FIG. 18 after the removal of a part of the cylinder.

FIG. 20 shows only the pistons, the crankshaft and the connecting rods of the engine of FIG. 15. The upper piston comprises a piston crown and piston rings that seal the upper side of the combustion chamber, a piston skirt that covers and uncovers the exhaust ports, a bridge that transfers the forces from the piston crown to the two side arms, the two side arms with the cylindrical sliders at their lower ends. The lower piston comprises a piston crown and piston rings that seal the lower side of the combustion chamber, a piston skirt that covers and uncovers the intake ports, four pillars surrounding the crankshaft, that transfer the force from the piston crown to the lower end, where the wrist pin is. Both pistons are drivingly coupled to the crankshaft by pullrods.

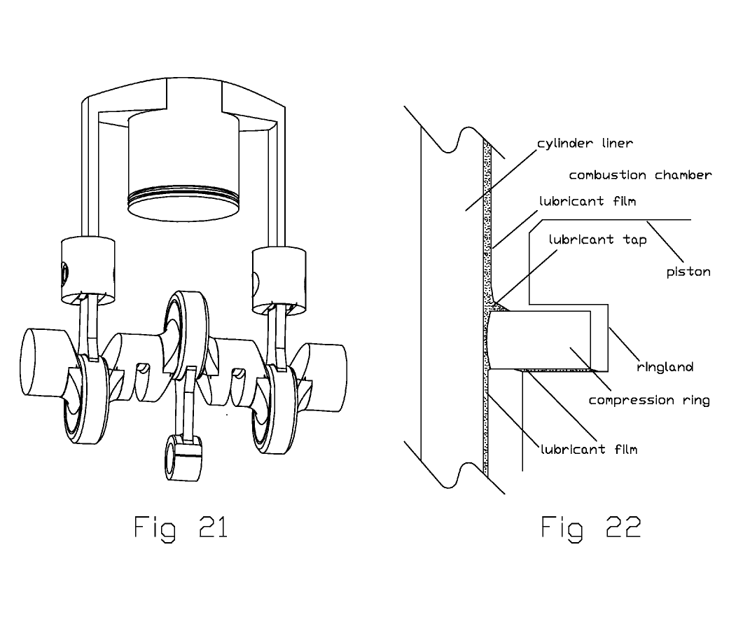

FIG. 21 shows the assembly shown in FIG. 20 after the removal of the lower piston.

FIG. 22 explains a way for the lubrication of the rings from within the combustion chamber.

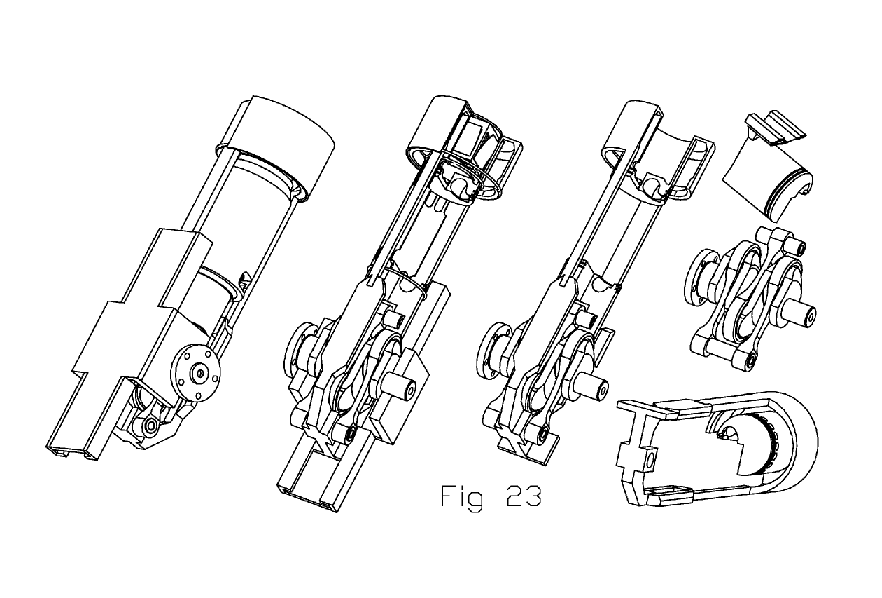

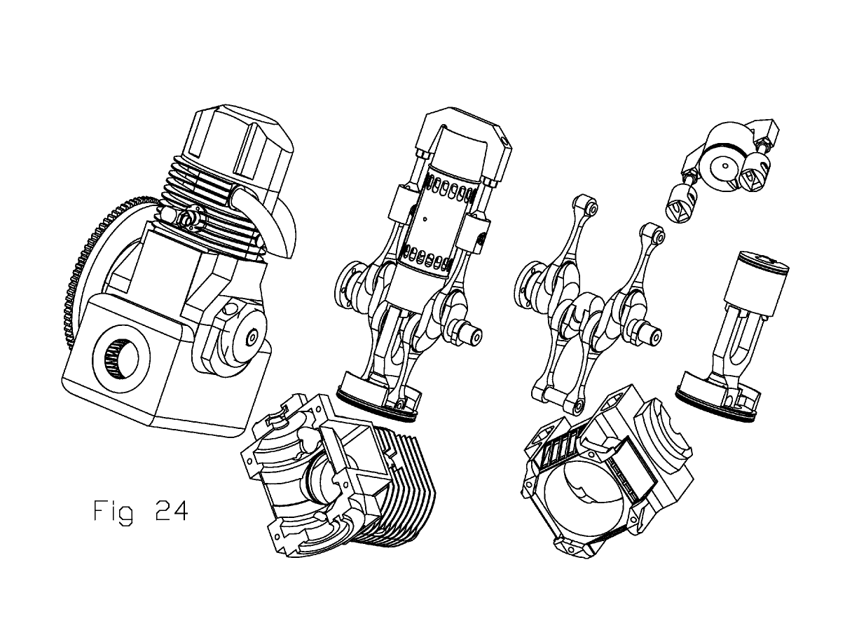

FIG. 23, like FIG. 6, shows a basic module wherein both opposed pistons are drivingly coupled to the unique crankshaft by pushrods. The big diameter piston at the backside of the intake piston is the scavenge piston. Ports on the skirt of the intake piston cooperate with the intake ports of the cylinder liner for the scavenging. The connecting rods can be arranged inside the cylinder footprint, enabling for more compact multi-cylinders. Details, animations, variations etc of this embodiment are at http://www.pattakon.com/pattakonPatPOC.htm

FIG. 24 shows the first prototype made and tested. Two connecting rods for the intake piston and two connecting rods for the exhaust piston are used. All connecting rods are pullrods. The big diameter piston of the scavenging pump is secured, by two ‘pillars’, to the intake piston and moves below the crankshaft. One-way valves trap the air into the big diameter cylinder and into the transfer ‘pipes’ waiting the intake ports to open. Details, photos, animations and videos of the prototype running on Diesel fuel are at http://www.pattakon.com/pattakonPatOP.htm

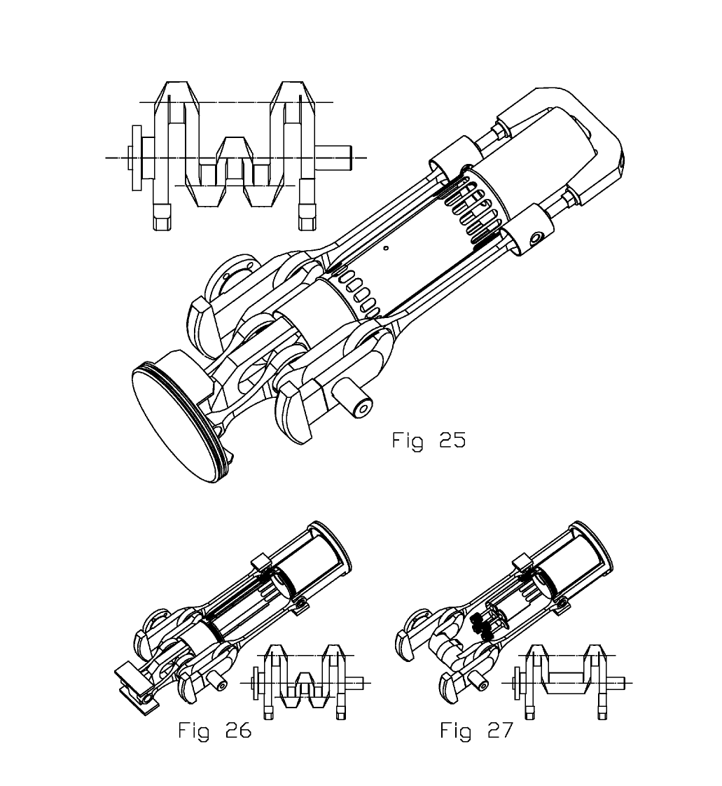

FIG. 25 shows another embodiment wherein the stroke of the intake piston is shorter than the stroke of the exhaust piston. Selecting properly the lengths of the connecting rods and the mass of the moving parts, the engine can be fully balanced. An advantage is a sorter engine for a given total piston stroke.

FIG. 26 shows a variation of the engine of FIG. 25. Here the intake piston and the scavenge piston, have the longer stroke.

FIG. 27 shows a variation of the engine of FIG. 26 wherein the stroke of the exhaust piston becomes zero. The exhaust piston becomes immovable and functions as a cylinder head. The exhaust gas leaves the combustion chamber through conventional exhaust poppet valves on the cylinder head. The intake piston skirt still controls conventionally the intake ports on the cylinder liner. It makes clear that the transition from the single piston engines to the opposed piston engines and vice-versa is a pure mathematical deduction involving only the reduction of a crank-throw to the limit, i.e. to zero.

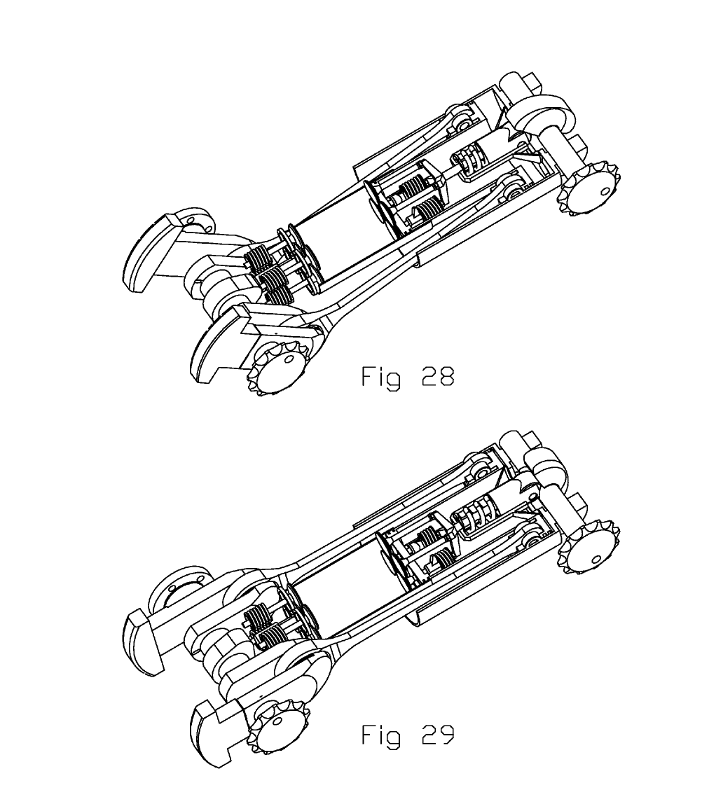

FIG. 28 shows a variation of the engine of FIG. 27. It is a port-less through-scavenging two-stroke engine. With the cylinder liner rid of intake and of exhaust ports, this engine combines a true ‘four-stroke’ lubrication and lubricant consumption, with the uniflow scavenging efficiency and with double valve area.

The piston and the piston rings are lubricated by the crankcase lubricant as in the conventional four-stroke engines, while the working medium is isolated from the crankcase lubricant as the working medium of the conventional four-stroke is isolated from the crankcase lubricant.

The connecting rods are disposed at the two sides of the cylinder, outside the cylinder footprint, to rid the space behind the piston of obstacles like a piston pin and a connecting rod, in order to free the flow of the working medium and to make space for the valve actuator and its mechanism.

The piston comprises valve seats and valve guides. The piston bears intake poppet valves and restoring springs. The exhaust valves are controlled conventionally, for instance by cams secured to the crankshaft. An intake camshaft rotates in synchronization with the crankshaft by means of sprockets, gears etc. A valve actuator, comprising valve lash adjusters, is displaced by the intake camshaft and is restored by restoring springs. During the compression, the combustion and the expansion, the intake valves move together with the piston. The right moment the exhaust valves open and the pressure inside the cylinder drops. At a crankshaft angle, the intake valves land on the valve actuator and start following its motion. Compressed air from the backside of the intake piston enters the cylinder, through the ports/holes on the piston crown, and scavenges the exhaust gas. The right moment the exhaust valves close. Compressed air continuous to enter the cylinder until the intake valves land on the valve seats on the piston crown and start following the piston motion. The compression begins.

Two of the main objectives of a right intake camlobe are: to allow the intake valves to pass smoothly, quietly and reliably from the motion with the piston to the motion with the valve actuator (and vice versa), and to protect the poppet valves of the piston, and their restoring springs, from excessive valve lifts.

By counterweights secured on the two intake camshafts, the even firing opposed cylinder version of this engine is full balanced. In FIG. 28 the crankshaft is at 135 degrees after the TDC; the exhaust valves are widely open; the intake valves have started opening.

FIG. 29 shows the engine of FIG. 28 with the crankshaft at 180 degrees after the TDC.

The intake valves are widely open, while the exhaust valves have started closing.

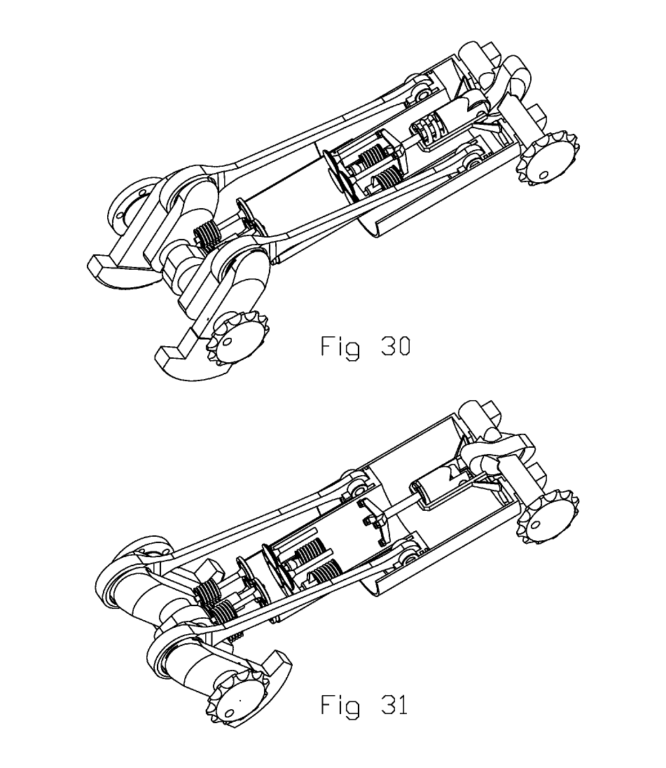

FIG. 30 shows the engine of FIG. 28 with the crankshaft at 225 degrees after the TDC. The intake valves are only slightly open, near to their valve seats on the piston crown. In a few degrees the piston will gently take them up from the valve actuator.

FIG. 31 shows the engine of FIG. 28 with the crankshaft at 300 degrees after the TDC.

The restoring springs and the pressure inside the cylinder decelerate the intake valves, keeping them firmly onto their valve seats on the piston crown.

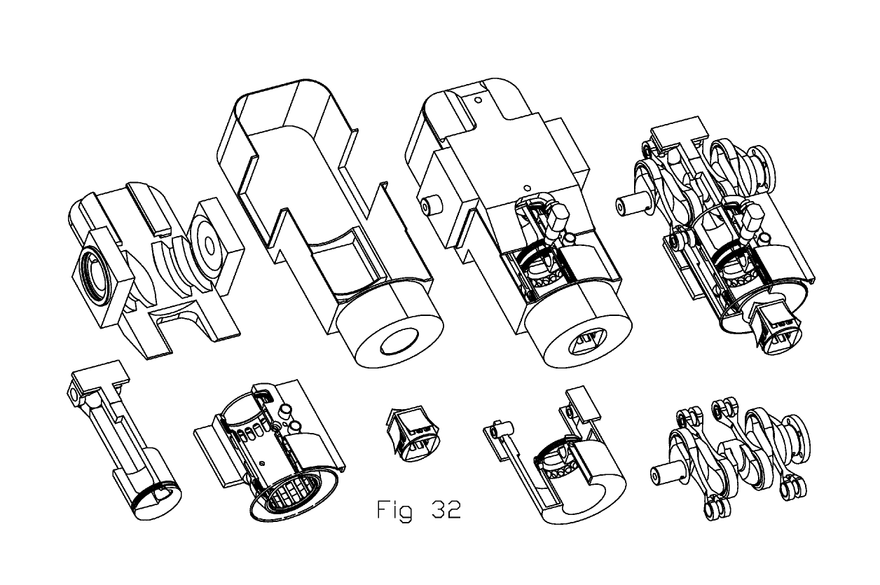

FIG. 32 shows an internal combustion engine having a basic module comprising: a single crankshaft having a plurality of crankpins; a single cylinder having a first piston and a second piston reciprocably disposed therein and forming a combustion chamber therebetween; a first connecting rod that drivingly couples the first piston to a corresponding crankpin on the crankshaft; a second connecting rod that drivingly couples the second piston to a corresponding crankpin on the crankshaft, said first and second connecting rods are both pullrods.

From bottom-left, FIG. 32: the exhaust piston with its slipper at the wrist pin end; the cylinder having, at both sides, sliders for the intake piston slippers, the cylinder liner with the exhaust ports and the long intake ports, the oval scavenge pump seal; the one way valve; the intake piston assembly comprising an intake piston with ports on its skirt, an oval scavenging piston and slippers at the wrist pin side; the crankshaft with the pullrods on it.

From top-left, FIG. 32: the basic-plate with the main crankshaft bearings and the sliders for the exhaust piston slipper; the oil pan comprising the scavenging pump cylinder; the complete engine; and the engine after the removal of the oil pan and of the plate with the main bearings.

The intake piston skirt has ports that cooperate with the cylinder liner intake ports/niches, eliminating the transfer pipes of the engine of FIG. 24. An one-way valve traps the air into the scavenge cylinder until the ports of the skirt of the intake piston align with the intake ports of the cylinder liner and the scavenging of the cylinder, by the compressed air, begins. The scavenge piston is ring-less; it has an elliptical/oval shape to compensate with the distance of the ‘intake crankpins’ without overly increasing the scavenge piston area. Immovable rings (seals) are in touch with the scavenge piston, keeping the lubricant at the crankcase side and the compressed air at the scavenging pump side, enabling a variety of scavenge cylinder shapes. The slippers bear the thrust loads.

FIG. 33 shows the engine of FIG. 32 in case of turbo-super-charging. The two exhaust pipes Ex1 and Ex2 feed the Ex3 turbine. The exhaust gas leaves through the turbine exhaust gas outlet Ex4. Air (or air and re-circulating exhaust gas) from the pipe In1 enters, through the pipe In2, into the turbocharger-compressor In3. The compressed air leaves the turbocharger-compressor through the pipe In4 to the cooler (not shown). From the cooler the compressed air returns to the pipe In5. A throttle valve In6 allows or stops the flow from the cooler to the space behind the intake piston (scavenging pump). When the delivered by the turbocharger pressure is low (like at cranking, at low revs, at light loads etc) the throttle valve In6 is kept closed, air enters through the one way valve In7 into the scavenge cylinder and is trapped there for the scavenging. When the turbocharger provides enough pressure, the throttle valve opens, the one way valve remains constantly closed (less noise, improved reliability) and the scavenging is made by exploiting the energy of the exhaust gas.

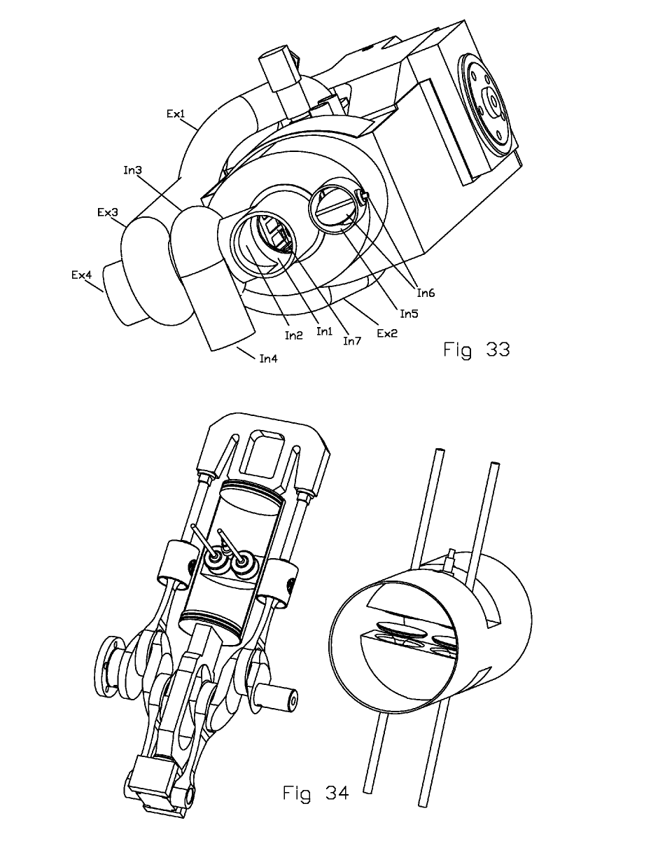

FIG. 34 shows a variation of the engine of FIG. 24. This engine is a four-stroke full-balanced single-cylinder, with intake and exhaust poppet valves at the middle of the cylinder, as shown at right.

In a first preferred embodiment, FIGS. 9 to 14, the crankshaft (1) drives, by means of the pullrods (2) and (3), the two opposed pistons (4) and (5) respectively.

The pullrod arrangement generates a longer piston dwell around the combustion, as compared to the conventional engine, and a shorter piston dwell during the scavenging.

The pistons (4) and (5) are reciprocably disposed into the same cylinder (6) and seal two sides of the same combustion chamber (7) therein.

The cylinder (6) comprises intake ports (8) and exhaust ports (9) that the reciprocating pistons cover and uncover.

The connecting rod of the upper piston and the connecting rod of the lower piston are, in case of symmetrical timing, always parallel. With equal diameters of the two opposed pistons, the forces applied to the crankshaft are parallel and equal, i.e. the total force on the main crankshaft bearings is zero. The same is true for the inertia forces: in case of equal mass of the two reciprocating assemblies, the total inertia force on the main bearings of the crankshaft is always zero.

In case of symmetrical timing, the engine balance can be perfect as regards the inertia forces and the inertia moments.

In case of asymmetrical timing, the pullrod-arrangement enables a smaller offset of the crankpins, thereby lesser spoiling of the dynamic balancing.

In a second preferred embodiment, FIGS. 15 to 21, the opposite to the combustion chamber side of the lower piston forms a scavenging pump. The diameter of the scavenging piston defines the scavenging ratio. Through proper ducts the fresh air flows to the intake ports awaiting the piston to uncover them.

In a third preferred embodiment, FIG. 8, the bore of the combustion cylinder increases towards the ports to reduce the friction and the wear of the piston rings and port bridges.

In a fourth preferred embodiment, FIGS. 6 and 23, both pistons are drivingly coupled to the same unique crankshaft by pushrods. In case of symmetrical timing, the balance of the inertia forces can be perfect.

The crosshead architecture eliminates the thrust loads from the pistons to the cylinder liner. Theoretically, the pistons never touch the cylinder liner. On this reasoning, only the piston rings need lubrication.

In the four stroke engines a lubricant film of about 0.002 mm (actually a dye of oil on the cylinder liner surface) is what actually protects the top compression ring from the dry contact with the liner.

The additional time provided by the pullrod arrangement for the injection and the combustion of the fuel, helps the biofuels and the neat vegetable oils with their longer ignition delays.

The better lubricity of the biofuel and the vegetable oil, relative to the Diesel, enables the lubrication of the compression rings from ‘inside’ as shown in FIG. 22. A small part of the injected vegetable oil inevitably, or intentionally, wets the cylinder liner. The compression rings sweep this spilled over quantity of fuel, building up a liquid seal all around the ring. A dynamic oil-sealing is achieved as the pistons reach the combustion dead center, with a cooling, lubricating and sealing effect.

A variation of the opposed piston arrangements is the case wherein the cylinder comprises two halves. The two halves may have different bores. The two halves may be arranged at some wide angle to provide asymmetrical timing etc.

The crankshaft may have some slight offset from the cylinder axis, as in the conventional engines. This also generates an asymmetrical timing.

Although the invention has been described and illustrated in detail, the spirit and scope of the present invention are to be limited only by the terms of the appended claims.

1. An internal combustion engine having a basic module comprising:
a single crankshaft having a plurality of crankpins;
a single cylinder having a first piston and a second piston reciprocably disposed therein and forming a combustion chamber therebetween, a first connecting rod that drivingly couples the first piston to a corresponding crankpin on the crankshaft;
a second connecting rod that drivingly couples the second piston to a corresponding crankpin on the crankshaft,
said first and second connecting rods are either both pullrods or both pushrods.

2. An internal combustion engine according claim 1 characterized in that the offset of the crankshaft is smaller than a quarter of the cylinder bore.

3. An internal combustion engine according claim 1 characterized in that at least one piston is drivingly coupled to the crankshaft by a pair of connecting rods disposed outside the cylinder at opposite sides of the cylinder.

4. An internal combustion engine according claim 1 characterized in that the cylinder is tapered being wider towards the ports.

5. An internal combustion engine comprising:
a crankshaft;
a combustion chamber;
a first piston sealing one side of said combustion chamber, said first piston is drivingly coupled to the crankshaft by a pullrod;
a second piston sealing an opposite side of said combustion chamber, said second piston is drivingly coupled to the crankshaft by a pullrod.

6. An internal combustion engine according claim 5 characterized in that at least one piston is drivingly coupled to the crankshaft by a pair of connecting rods disposed at opposite sides of the combustion chamber.

7. A through-scavenging two-stroke engine wherein:
the pistons and the piston rings are lubricated by the crankcase lubricant as in the conventional four-stroke engines,
the working medium is isolated from the crankcase lubricant as the working medium of the conventional four-stroke is isolated from the crankcase lubricant.

8. A through-scavenging two-stroke engine according claim 7, comprising at least:
a crankcase;
a cylinder forming a combustion chamber therein;
a cylinder head sealing one side of the combustion chamber, the cylinder head comprising a port and a poppet valve controlling the port of the cylinder head;
a crankshaft rotatably mounted to the crankcase, the crankshaft having a crankpin;
a connecting rod;
a piston reciprocally disposed into the cylinder, the piston is sealing another side of the combustion chamber, the piston is drivingly coupled to the crankpin of the crankshaft by the connecting rod, the piston is separating the combustion chamber from the space behind the piston,
the piston comprising piston rings slidably fitted into the cylinder, the piston comprising a port for the communication of the combustion chamber with the space behind the piston, the piston comprising a poppet valve controlling the port of the piston, during the scavenging the port of the piston and the port of the cylinder head are open,
the crankcase lubricant is lubricating the piston and the piston rings while the piston rings are controlling the lubricant leakage from the crankcase to the combustion chamber;
additional sealing means are controlling the lubricant leakage from the crankcase to the space behind the piston,
thereby a through-scavenging two-stroke engine with four-stroke lubrication and lubricant consumption results.

9. A through-scavenging two-stroke engine according claim 7, comprising at least:
a crankcase;
a cylinder forming a combustion chamber therein;
a cylinder head sealing one side of the combustion chamber, the cylinder head comprising a port and a poppet valve controlling the port of the cylinder head;
a crankshaft rotatably mounted to the crankcase, the crankshaft having a pair of crankpins;
a pair of connecting rods;
a piston reciprocably disposed into the cylinder, the piston is sealing another side the combustion chamber, the piston is drivingly coupled to the crankshaft by the pair of connecting rods disposed at the two sides of a cylinder, outside the cylinder footprint, the piston is separating the combustion chamber from the space behind the piston, the piston comprising piston rings slidably fitted into the cylinder, the piston comprising a port for the communication of the combustion chamber with the space behind the piston, the piston comprising a poppet valve controlling the port of the piston, during the scavenging the port of the piston and the port of the cylinder head are open, the crankcase lubricant is lubricating the piston and the piston rings while the piston rings are controlling the lubricant leakage from the crankcase to the combustion chamber,
a secondary cylinder is disposed around the space behind the piston;
by secondary piston rings the piston is controlling the leakage of lubricant from the crankcase to the space behind the piston.

10. A through-scavenging two-stroke engine according claim 7, comprising at least:
a crankcase;
a cylinder forming a combustion chamber therein;
a cylinder head sealing one side of the combustion chamber, the cylinder head comprising a port and a poppet valve controlling the port of the cylinder head;
a crankshaft rotatably mounted to the crankcase, the crankshaft having a crankpin;
a connecting rod;
a piston reciprocably disposed into the cylinder, the piston is sealing another side of the combustion chamber, the piston is drivingly coupled to the crankpin of the crankshaft by the connecting rod, the piston is separating the combustion chamber from the space behind the piston,
the piston comprising piston rings slidably fitted onto the cylinder, the piston comprising a port for the communication of the combustion chamber with the space behind the piston, the piston comprising a poppet valve controlling the port of the piston, during the scavenging the port of the piston and the port of the cylinder head are open;
a cam rotating in synchronization to the crankshaft;
a valve actuator disposed in the space behind the piston, the valve actuator is displaced under the camming action of the cam, the poppet valve of the piston, seated on the port of the piston, follows the piston motion during the compression, the combustion and the expansion, until the moment it lands onto the valve actuator, then it follows the motion of the valve actuator keeping open the piston port and allowing the communication of the combustion chamber with the space behind the piston, until the moment the poppet valve of the piston lands back onto the piston, closing the port of the piston and following the piston motion;
the profile of the cam is such that:
the maximum valve lift of the poppet valve of the piston is less than 60% of the diameter of the poppet valve of the piston,
and at the moments the poppet valve of the piston lands onto the valve actuator or onto the piston, the valve actuator speed differs less than 10% than the piston speed.
